(19) United States
(12) Patent Application Publication
(10) Pub. No.: US 2011/0174555 A1
(43) Pub. Date: Jul. 21, 2011

(54) CRAWLER TRAVEL GEAR AND CRAWLER-MOUNTED CRANE

(75) Inventor: Hans-Dieter WILLIM, Ulm-Unterweiler (DE)

(73) Assignee: Liebherr-Werk Ehingen GmbH, Ehingen/Donau (DE)

(21) Appl. No.: 13/009,966

(22) Filed: Jan. 20, 2011

(30) Foreign Application Priority Data
Jan. 20, 2010 (DE) 20 2010 001 192.2

(51) Int. Cl. B62D 55/14; B62D 55/06; B62D 55/08

(52) U.S. Cl. 180/9.52; 305/141

(57) ABSTRACT

A crawler travel gear that can be applied to a crawler-mounted crane. The crawler travel gear includes a crawler carrier, rollers arranged at the crawler carrier and a crawler chain, with a respective adjustment mechanism provided in the front region and rear region of the crawler carrier for selectively adjusting the contact surface of the crawler carrier relative to an underlying surface.

### CROSS REFERENCE TO RELATED APPLICATIONS

The present application claims priority under 35 U.S.C. §119 to German Utility Model Application No. 20 2010 001 192.2 (filed on Jan. 20, 2010), which is hereby incorporated by reference in its entirety.

### FIELD OF THE INVENTION

The present invention relates to a crawler travel gear, in particular, a crawler travel gear of a crawler-mounted crane, having a crawler carrier, having rollers arranged at the crawler carrier and having a crawler chain. The present invention further relates to a crawler-mounted crane having a corresponding crawler travel gear.

### BACKGROUND OF THE INVENTION

Generally, a crawler travel gear includes a chain having track pads that usually lay at the top on carrier rollers and on the ground side on rollers, while it runs over drive wheels or idler wheels arranged at the front and at the rear at the crawler carrier.

FIG. 1 shows a sectional view along a vertical longitudinal plane of a crawler travel gear known from prior art. The crawler travel gear usually has a chain 14 having track pads 12 and lying at the top on carrier rollers 13 and on the ground on rollers 20. The rollers 20 are held in a carrier frame 1. The two drive wheels 10 serve the drive of the crawler travel gear. Embodiments having a single drive wheel 10 to drive the chain 14 are likewise possible.

A crawler-mounted crane having a corresponding crawler travel gear has, viewed from the undercarriage, front and rear tilting edges 21 which are defined by the frontmost and rearmost rollers 20 of the crawler travel gear. The position and the size of the total center of gravity 50 of the crawler-mounted crane is made up of all single centers of gravity. The rollers 20 transmit the effective forces via the track pads 12 of the chain 14 to the ground. The forces which occur are only output uniformly via the total contact surface B1 of the chain 11 to the ground on a central position of the total center of gravity 50 in the region between the two tilting edges 21. A displacement of the total center of gravity 50 in the direction of one of the tilting edges 21 results in a triangular introduction of force/ground pressure in the form of the surface A1 beneath the surface B1 with a linearly increasing force/ground pressure in the direction of the tilting edge 21. The surface A1 therefore shows a diagram of the ground pressure rising in the direction of the tilting edge 21. The more closely the total center of gravity 50 migrates to the tilting edge 21, the larger the force or the dangerous force peaks become which the frontmost roller 20 transmits to the ground. Since the load-bearing capacity of the ground is limited to a maximum possible force, the ground yields once the maximum force has been exceeded and the center of gravity 50 is further displaced in the direction of the tilting edge 21 until the total crane tilts about the tilting edge 21.

Since the ground does not represent a completely flat surface in practice, the actual contact surface B1 of the chain 14 is not known. The calculation of the ground pressure over the total unknown contact surface B1 is therefore only possible imprecisely or is hardly possible.

A crawler-mounted crane in which the contact surface of the stationary crawler can be reduced during cornering is proposed to improve the steering capability of a crawler-mounted crane having such a crawler travel gear in DE 20 2006 001 558 U1 to whose content reference is made in full. In this respect, the contact surface is limited to the central region of the crawler travel gear by means of runners or vertically adjustable rollers which are arranged in the central region of the crawler travel gear.

A further implementation for reducing the contact surface of the crawler chain is known from DE 20 2007 017 896 U1 to which reference is likewise made in full.

### SUMMARY OF THE INVENTION

Embodiments of the invention has set itself the task of providing a crawler travel gear for a crawler-mounted crane whose stability is simple to monitor and whose steering capability is simultaneously optimized.

Embodiments are related to a crawler travel gear that can include at least one of the following: a crawler carrier; rollers arranged at the crawler carrier; a crawler chain surrounding the rollers and having a plurality of contact surfaces which contact an underlying surface, the contact surfaces being located at a front region and a rear region of the crawler carrier; and adjustment means provided at the front region and the rear region of the crawler carrier for spatially adjusting the contact surfaces relative to the underlying surface.

Embodiments are related to a crawler-mounted crane that can include at least one of the following: a crawler travel gear including a crawler carrier having a plurality of rollers; a crawler carrier having a first plurality of rollers connected thereto that are not selectively vertically displaceable; a crawler chain having a plurality of contact surfaces located at a front region and a rear region of the crawler carrier which are adapted to contact an underlying surface; an adjustment mechanism provided at each of the contact surfaces and including a second plurality of rollers that are selectively vertically displaceable, an adjustment box connected to the second plurality of rollers and an actuator adapted to spatially displace the adjustment box with respect to the crawler carrier to thereby permit selective vertical adjustment of the second plurality of rollers relative to the first plurality of rollers; and at least one force measuring device adapted to monitor the stability of the crawler-mounted crane by detecting forces applied at each contact surface and thereby permit the selective vertical adjustment of the second plurality of rollers.

Embodiments are related to a crawler travel gear that can include at least one of the following: a carrier chain having at least one first contact surface and at least one second contact surface spaced from the at least one first contact surface and equal in length to the at least one first contact surface; an adjustment mechanism provided at each respective contract surface and having a predetermined number of adjustment rollers, the adjustment mechanism being adapted to selectively spatially adjust the adjustment rollers relative to the chain; and a force measuring system adapted to detect forces applied at each adjustment mechanism.

Such a crawler travel gear, in particular, a crawler travel gear for a crawler-mounted crane, in this respect has a crawler carrier, rollers arranged at the crawler carrier and a crawler chain. Provision is made in accordance with embodiments of the invention in this respect that a respective means for adjusting the contact surface of the crawler carrier is provided in the front and rear regions of the crawler carrier. Defined contact surfaces of the crawler chain with respect to their size (e.g., length) and their spatial position can hereby be provided in that the position of the chain region of the crawler chain close to the ground surface is accordingly adapted by the means in the front and rear regions of the crawler travel gear.

There is a possibility, on the one hand, that the contact surface of the crawler chain on the ground is reduced by the means so that the steering forces to be used become considerably smaller. On the other hand, there is the possibility that the limitation to two contact surfaces of equal size permits a uniform force introduction into the ground below the two contact surfaces and allows a constant ground pressure to be adopted in the contact region.

Starting from a starting position of the crawler travel gear with a complete contact surface of the chain, either two contact surfaces of equal size can be set by way of the means, in particular selectively, in the front and rear regions of the crawler carrier. The initially named critical force peaks of the force distribution in the region of the front and rear rollers are avoided. Alternatively, the contact surface of the crawler chain can be changed such that a single contact surface arises in the central region of the crawler carrier to shorten the contact length.

It is conceivable that the at least one means includes at least one vertically adjustable roller. Preferably, at least one respective vertically adjustable roller is arranged particularly in the front and rear regions and form two contact surfaces of the crawler chain of equal size in the front and rear regions of the crawler travel gear by pressure build-up on the crawler chain. Alternatively, the vertically adjustable rollers can be raised below the spatial level of the other rollers. The resulting single contact surface of the crawler chain is reduced to the middle region of the crawler travel gear so that the steering capability of the crawler-mounted crane is considerably improved by shortening the contact length.

Provision can be made in an advantageous manner that at least one vertically adjustable roller is journalled in a box which is displaceable in a vertical direction with respect to the crawler carrier. The vertically displaceable rollers can hereby be urged toward and away from the chain, with the arrangement in a box displaceable in the vertical direction enabling a construction which is as inexpensive as it is stable.

Provision is furthermore made in an advantageous manner that the box is adjustable in the vertical direction with respect to the crawler carrier via one or more actuators, in particular via one or more hydraulic cylinders so that at least one roller can be moved downwardly toward the chain in the front and rear regions of the crawler travel gear. The total contact surface is hereby in turn in accordance with the invention reduced to the two contact surfaces of equal size in the front and rear regions of the crawler travel gear. Alternatively, the boxes or the rollers can be raised upwardly in a manner moving away from the chain via the at least one actuator so that a reduced contact surface is formed in the central region of the crawler travel gear.

In a preferred embodiment of the invention, a plurality of rollers are journalled at least one box. A respective three rollers are particularly preferably journalled within a box in the front and rear regions of the crawler travel gear.

It is also of advantage that at least one roller is vertically non-displaceably journalled between the means, in particular between the vertically adjustable rollers.

In a further advantageous manner, at least one force measuring system for the force measurement of the forces applied in the region of the means is provided. Preferred embodiments are given by the use of a load cell or of a measurement bridge for force measurement. Any desired alternative force measuring systems can naturally be used.

The detection of the compression forces applied in the region of the means has proved particularly advantageous. The forces of the crawler travel gear distributed over the two contact surfaces of equal size can hereby be detected and supplied to a control unit. Force measuring systems of this kind are known, for example, from DE 20 2006 017 724 U1 and DE 10 2008 021 627 A1 to which reference is explicitly made at this point. It is also conceivable that the forces which occur can be detected directly within the means via a measurement apparatus within the means.

The present invention further includes a crawler-mounted crane having a crawler travel gear such as was described above. Such a crawler-mounted crane obviously has the same advantages as were presented above with respect to the crawler travel gear.

In a preferred embodiment of the crawler-mounted crane in accordance with the invention, the crawler-mounted crane provides a stability monitoring which monitors the stability of the crawler-mounted crane in dependence on the measured uniform ground pressure of the two contact surfaces of equal size and/or on the position of the tilting edges and/or on the position of the total center of gravity. Only the use of the crawler travel gear in accordance with the invention allows the reliable technical measurement detection of the applied ground pressure. The stability monitoring can in particular also be advantageously used during the assembly and dismantling procedure. Reliable statements with respect to the applied forces or the ground pressure can also be made here for a plurality of upright states of the crane. An alignment of the crane in the horizontal plane is particularly preferably assisted by the stability monitoring.

Provision can furthermore be made that the detected forces in the region of the means, preferably four measured values for the two respective contact surfaces on both sides of the crawler travel gear, are conducted further to a controller of the crawler-mounted crane. The controller can output and indicate the forces directly or can make further calculations on the basis of these values. A calculation of the applied ground pressure is conceivable, for example, by multiplication of the respective detected measured force value by the known contact surface. A calculation of the danger of tilting is furthermore possible by determining the distance between the total center of gravity and the tilting edge.

### BRIEF DESCRIPTION OF THE DRAWINGS

Further features, details and advantages of the invention will be explained in more detail with reference to embodiments shown in the drawings.

FIG. 1 is a schematic side view of the crawler travel gear known in accordance with the prior art.

Example FIG. 2 illustrates a schematic side view of the crawler travel gear in accordance with embodiments of the invention.

Example FIG. 3 illustrates an enlarged side view of the crawler travel gear in accordance with embodiments of the invention of example FIG. 2.

Example FIG. 4 illustrates a side view of the crawler travel gear in accordance with embodiments of the invention during cornering.

### DETAILED DESCRIPTION OF EMBODIMENTS

Example FIG. 2 shows a schematic side view of the crawler travel gear in accordance with embodiments of the invention which provides a respective means in the front region and in the rear region of the crawler carrier for setting the contact surface of the crawler carrier 101. The crawler travel gear usually has a chain 140 having track pads and lying spatially at the top on carrier rollers 130 and on the ground on lower rollers 200, 200a. The lower rollers 200, 200a are held in a carrier frame 101.

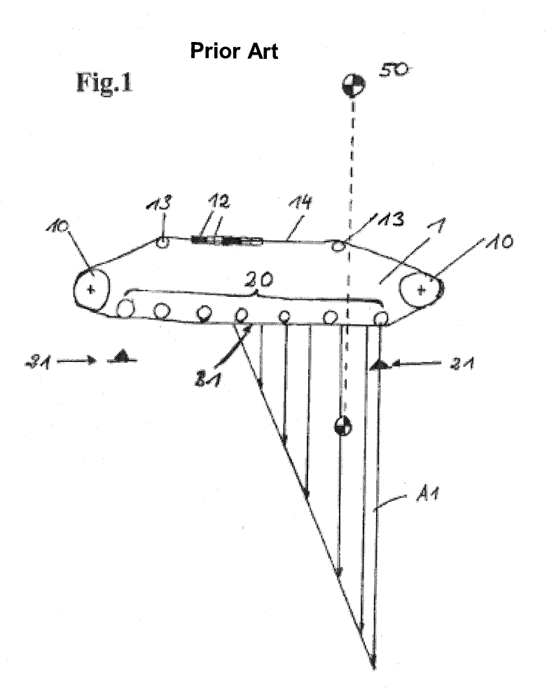

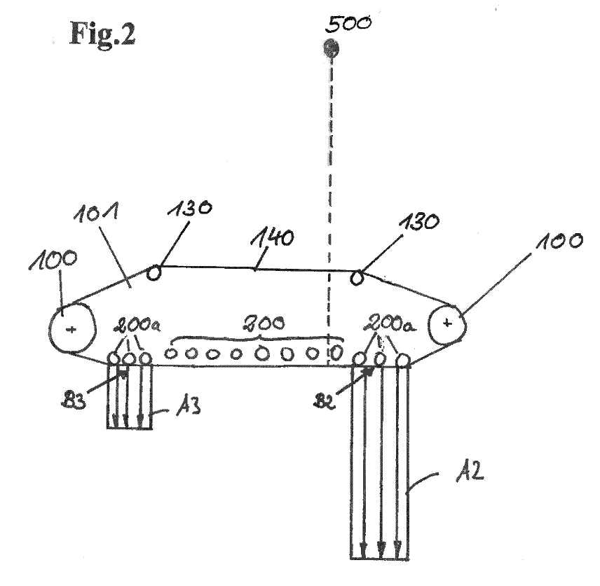

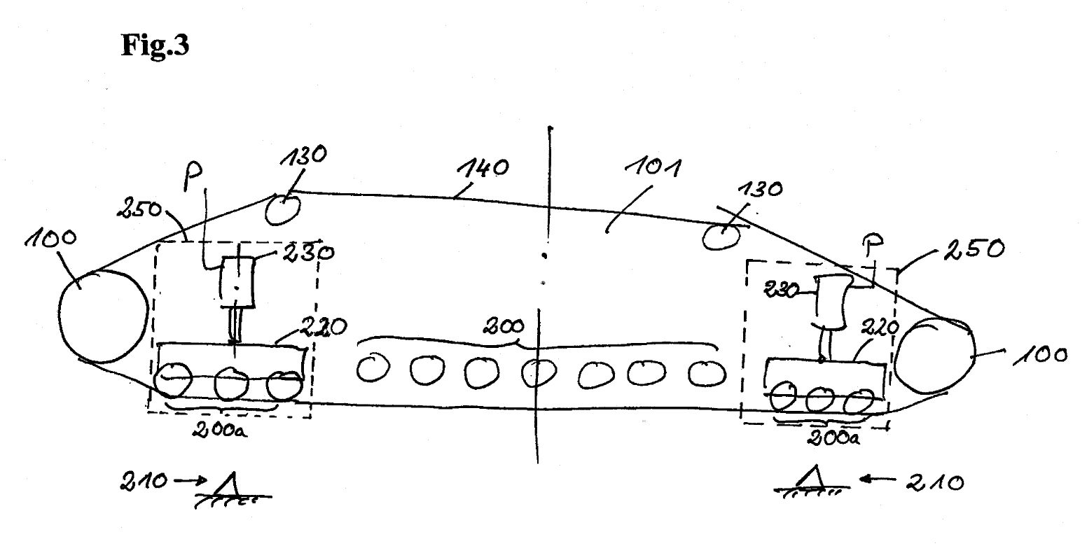

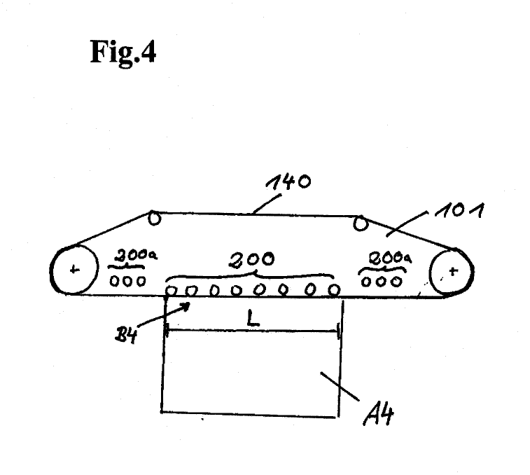

In accordance with embodiments of the invention, the contact surface of the chain 140 is limited to two contact surfaces B2, B3 of equal size (e.g., length) by the means arranged in each case in the front region and rear region of the crawler carrier 101 in that a respective plurality of rollers of lower rollers 200a are selectively vertically (e.g., upwardly and downwardly) adjusted in the direction of the chain 140. In accordance with embodiments of the invention, the plurality of rollers 200a at respective contact surfaces B2, B3 of lower roller 200 may equal three. The sum of the two individual contact surfaces B2, B3 produces the contact surface B1 shown in FIG. 1 if the total center of gravity 500 of a crawler-mounted crane or of the crawler travel gear corresponds to the total center of gravity 50 of FIG. 1 with respect to amount and position.

The depicted arrows of example FIG. 2 symbolize the force introduced into the ground below the contact surfaces B2, B3. It can be seen from FIG. 2 that a uniform introduction of force into the ground can be achieved by the setting of the contact surfaces B2, B3 in accordance with embodiments of the invention and consequently a uniform ground pressure is achieved which is circumscribed by the ground surfaces A2, A3 which are contacted by the crawler carrier 101 at the contact surfaces B2, B3. The contact surfaces B2, B3 are naturally always identical with respect to their surface size (e.g., length).

In accordance with embodiments of the invention, a crawler-mounted crane or a crawler travel gear is realized whose stability is simple to monitor since uniform introductions of force below the known contact surfaces B2, B3 can always be assumed.

Example FIG. 3 shows an enlarged side view of the crawler travel gear in accordance with embodiments of the invention. A respective three rollers of lower rollers 200a are journalled at a respective box 220 each in the front region and rear region of the crawler travel gear and are displaceable with respect to the crawler carrier 101 in a vertical direction so that the rollers 200a are downwardly and upwardly movable toward and away from the chain 140. Hydraulic cylinders 230 are furthermore provided via which the two boxes 220 are displaceable in the vertical direction. The hydraulic cylinders 230 can thereby press, manipulate or otherwise move the boxes 220 downwardly out of the crawler carrier 101 so that the rollers 200a are pressed downwardly toward the chain 140. The rollers 200 arranged between the two boxes 220 and not at contact surfaces B2, B3 are, in contrast, non-displaceably journalled at the crawler carrier 101 itself.

In the region of the means 250, i.e., in the region of the two hydraulic cylinders 230, a force measuring system is installed for detecting forces which occur in this part region of the crane and forwards or otherwise transmits the resulting data to a crane controller or to an overload safety device. The determination of the forces applied to the box 220 or to the hydraulic cylinders 230 preferably takes place via the pressure measurement of the piston-in-cylinder unit of the hydraulic cylinder 230. The forces determined at the total of four contact surfaces B2, B3 are transferred to a controller for stability monitoring. The center of gravity 500 of the crane with load is determined from this by the controller. The tilting edges 210 are geometrically preset and known to the controller. The respective applied ground pressure can furthermore be determined sufficiently accurately on the basis of the detected individual forces at the support points or contact surfaces B2, B3. A reliable and continuous stability monitoring is hereby implemented within the controller. The stability monitoring can in particular also be meaningfully used during the assembly or disassembly procedure. A crawler-mounted crane in accordance with the invention can above all actually be aligned in an horizontal plane during the crane work without a complex and heavy additional support being required for this purpose which has in particular to be transported separately with the crawler-mounted crane and has to be disassembled or assembled.

Example FIG. 4 shows a schematic side view of the crawler travel gear in accordance with embodiments of the invention during a steering movement. The vertically adjustable boxes 220, in particular, the vertically adjustable rollers 200a, are moved upwardly against the crawler chain 140 so that the steering capability of the crawler-mounted crane or of the crawler travel gear is considerably enhanced by the reduction of the contact length L. The contact surface B4 of the crawler travel gear in accordance with embodiments of the invention is accordingly reduced to the middle region of the crawler travel gear which is supported by the non-vertically adjustable steering rollers 200.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A crawler travel gear comprising:
a crawler carrier;
rollers arranged at the crawler carrier;
a crawler chain surrounding the rollers and having a plurality of contact surfaces which contact an underlying surface, the contact surfaces being located at a front region and a rear region of the crawler carrier; and
adjustment means provided at the front region and the rear region of the crawler carrier for selectively spatially adjusting the contact surfaces relative to the underlying surface.

2. The crawler travel gear of claim 1, wherein the plurality of contact surfaces have equal lengths.

3. The crawler travel gear of claim 2, wherein the adjustment means includes at least one vertically adjustable roller.

4. The crawler travel gear of claim 1, wherein the adjustment means comprises at least one vertically adjustable roller.

5. The crawler travel gear of claim 4, wherein the adjustment means further comprises an adjustment box which is operatively connected to the at least one vertically adjustable roller and which is vertically displaceable with respect to the crawler carrier.

6. The crawler travel gear of claim 5, wherein the adjustment means further comprises at least one actuator adapted to vertically adjust the adjustment box with respect to the crawler carrier.

7. The crawler travel gear of claim 6, wherein the at least one actuator comprises at least one hydraulic cylinder.

8. The crawler travel gear of claim 7, wherein three rollers of the plurality of rollers are operatively connected to the adjustment box.

9. The crawler travel gear of claim 3, wherein at least one roller of the plurality of rollers located between the front region and the rear region is not vertically displaceable.

10. The crawler travel gear of claim 1, further comprising:
at least one force measuring system which is adapted to measure a force applied to the adjustment means.

11. The crawler gear of claim 10, wherein the at least one force measuring system comprises one of a load cell and a measurement bridge.

12. A crawler-mounted crane comprising:
a crawler travel gear including:
a crawler carrier having a first plurality of rollers connected thereto that are not selectively vertically displaceable;
a crawler chain having a plurality of contact surfaces located at a front region and a rear region of the crawler carrier which are adapted to contact an underlying surface;
an adjustment mechanism provided at each of the contact surfaces and including a second plurality of rollers that are selectively vertically displaceable, an adjustment box connected to the second plurality of rollers and an actuator adapted to spatially displace the adjustment box with respect to the crawler carrier to thereby permit selective vertical adjustment of the second plurality of rollers relative to the first plurality of rollers; and
at least one force measuring device adapted to monitor the stability of the crawler-mounted crane by detecting forces applied at each contact surface and thereby permit the selective vertical adjustment of the second plurality of rollers.

13. The crawler-mounted crane of claim 12, further comprising:
a controller adapted to monitor the stability of the crawler-mounted crane in dependence of at least one of a uniform ground pressure of the contact surfaces, the spatial location of tilting edges, and the spatial location and size of the total center of gravity of the crawler-mounted crane.

14. The crawler-mounted crane of claim 12, wherein the second plurality of contact surfaces have equal lengths.

15. The crawler-mounted crane of claim 12, wherein the actuator comprises a hydraulic cylinder.

16. A crawler travel gear comprising:
a carrier chain having at least one first contact surface and at least one second contact surface spaced from the at least one first contact surface and equal in length to the at least one first contact surface;
an adjustment mechanism provided at each respective contract surface and having a predetermined number of adjustment rollers, the adjustment mechanism being adapted to selectively spatially adjust the adjustment rollers relative to the carrier chain; and
a force measuring system adapted to detect forces applied at each adjustment mechanism.

17. The crawler travel gear of claim 16, wherein the force measuring system detects forces applied at the adjustment mechanism.

18. The crawler travel gear of claim 16, wherein the adjustment mechanism further comprises an adjustment box connected to the adjustment rollers and an actuator connected to the carrier box to permit selective spatial adjustment of the adjustment box and the adjustment rollers relative to the chain.

19. The crawler travel gear of claim 18, wherein the force measuring system detects forces at the actuator.

20. The crawler travel gear of claim 16, wherein the predetermined number of adjustment rollers comprises three.
